(19) United States
(12) Patent Application Publication
(10) Pub. No.: US 2010/0176670 A1
(43) Pub. Date: Jul. 15, 2010

(54) Machine cooling scheme

(75) Inventor: Carlos F. Gottfried, Iztapalapa (MX)

Correspondence Address: KLARQUIST SPARKMAN, LLP, 121 SW SALMON STREET, SUITE 1600, PORTLAND, OR, 97204, US

(73) Assignee: Power Group International Corporation

(21) Appl. No.: 12/319,870

(22) Filed: Jan. 12, 2009

(51) Int. Cl. H02K 1/32

(52) U.S. Cl. 310/61

(57) ABSTRACT

A motor, generator, or other machine with an improved rotor and stator structure providing radial slots in the rotor and stator can create an improved cooling scheme, or airflow pattern. Such a cooling scheme can be adapted for both totally enclosed and open drip proof motors, generators, and other machines easily, such that the two types of machines may share manufacturing facilities. The improved airflow pattern can provide for a cooling material to first flow in an axial direction along the axis of the rotor, then in a radial direction from the center of the machine outward, then again in an axial direction, and finally in a radial direction. At the end of the airflow pattern, in totally enclosed machines, the cooling material may flow radially inwards and begin the cycle again, whereas in open drip proof machines, the cooling material may flow radially outward again and exit the machine.

### FIELD

The present disclosure relates to a method and system for cooling electric machines, such as electric generators and motors.

### BACKGROUND

Machines, such as motors, generators, and others, often generate heat during operation, and require a cooling mechanism to prevent overheating, damage to components of the machine, and/or destruction of the machine itself. Efficient heat removal can also improve machine output. Even with significant cooling, there can still be significantly elevated temperatures within active material of the machine, such as within windings and magnetic flux paths. Cooling is important to keep the elevated temperatures in the machine's active materials below a specified temperature range, thereby extending the machine's life significantly. Different cooling schemes have been developed for different types of machines, such as for totally enclosed and open drip-proof machines.

In some environments, such as marine environments, it is necessary to enclose a machine so that no foreign substances can enter and damage components of the machine or motor. These machines are herein referred to as totally enclosed (TE). In non-corrosive environments, open drip-proof (ODP) machines are more commonly used. ODP machines can be much lighter and less expensive to manufacture than TE machines due to several differences in manufacturing of the different machines.

First, most machines are provided with back iron in the stator, where the back iron can provide a mounting surface for the structural frame. The stator of a TE machine typically has much more back iron than the stator of an ODP machine has. TE machines often require more back iron because the back iron provides a conduction cooling path necessary to carry heat away from the machine frame. Second, because heat can pose greater problems for TE machines, thicker copper wire is often used in an equivalent winding to reduce resistive losses, thus requiring more copper than would be required for an ODP machine of equivalent capability. Third, the prior art TE cooling approach is less effective than the prior art ODP approach of passing fresh air axially through the machine. For these and other reasons, TE machines are typically larger and more expensive than ODP machines.

Traditionally, the design of active material (e.g. magnetic steel and copper windings) and structural material (e.g. frames and enclosures) have been significantly different in the two different frame types. Thus, because of design and manufacturing differences, producing both types of machines requires significantly more manufacturing infrastructure than would be required to produce one type alone.

### SUMMARY

Certain embodiments of a novel airflow and cooling scheme can address these and other issues with prior art machines. For example, some embodiments of a cooling system for a TE machine do not require extra heavy and/or costly materials beyond the materials that are required for an ODP machine. Further, some presently disclosed embodiments allow for an ODP machine to be easily adapted for use as a TE machine. For example, in some embodiments, the active material design and the bulk of the structural material design of a machine are common to both a TE machine version and an ODP machine version. This can allow for many manufacturing advantages as well as the ability to convert a machine from TE to ODP (or vice-versa) in the field.

Some embodiments utilize an improved cooling approach. In one embodiment of an ODP machine, clean, fresh, axial airflow can enter the machine at a back end (opposite a connection or coupling to a gearbox or other device driving or being driven by the machine) of the machine. This axial flow can continue through a rotor spider (the internal rotor support structure) of the machine until it reaches radial rotor cooling slots. These slots can pass through rotor active material and can form a centrifugal fan and opening for airflow to turn and pass radially through the machine. At the radial rotor slots, the cooling air may turn and be moved through the rotor slots until the air reaches an air gap between the rotor and a stator. The air can continue to move radially through stationary radial slots in the stator. At an outer diameter of the stator's active material, the air can turn again and flow axially towards the back end of the machine. At the back of the machine, the axially flowing air can be deflected approximately 90 degrees by fan blades mechanically connected to the rotor, and the air can then exit the machine. This axial, radial, axial, radial airflow can be advantageous over prior art machine airflow patterns.

In some alternative embodiments, instead of fan blades, stationary guides can direct the air out of the machine.

In one embodiment of a TE machine, no exchange of outside air within the machine is required, thus resulting in a substantially closed and internal cooling path. Air can move axially from the back of the machine to one or more heat exchangers. Heat exchangers can be, for example, air-to-air exchangers, air-to-water exchangers, or others. Heat exchangers can include internal radiator or one or more heat exchanger fins. In embodiments having an internal radiator, the radiator can remove heat, transferring it to the environment outside of the machine via a cooling fluid. In embodiments having heat exchanger fins, heat is transferred via conduction through a back plate of the machine. As the air moves through the heat exchanger, it continues axially through the rotor spider until it encounters the rotor slots. At the rotor slots, the cooling air can be diverted by ninety degrees, thus causing the air to flow in a radial direction. The cooling air can move through the radial rotor slots past the air gap and then into and through radial stator slots. At the outside diameter of the stator's active material, the airflow again can be diverted ninety degrees, resulting in an axial airflow flowing towards the back end of the machine. At the back of the machine, the air can flow radially inward and then forward axially back through a heat exchanger, such as a cooling radiator or fins. In this manner the machine can be cooled more efficiently, using fewer materials, and resulting in a machine that is less expensive and easier to build.

Disclosed embodiments of a machine, such as a motor or a generator, can comprise a housing that at least partially encloses the machine, a rotor body positioned at least partially within the housing and having a length defining an axial direction, and a stator spaced radially from the rotor body. The rotor body and the stator can each have at least one radially extending slot such that a cooling material, such as one or more cooling fluids or one or more cooling gases, can flow through the slots in a radial direction, such as from the center of the machine towards the housing. Some embodiments may comprise a plurality of radially extending slots, wherein each slot is axially adjacent each other and substantially regularly spaced in an axial direction. The ratio of the width (measured in the axial direction) of the one or more slots to the width of the active rotor material or the active stator material between the slots can be adjusted for particular embodiments. Such adjustment can optimize the electromagnetic design and/or maximize power output while minimizing the corresponding rise in temperature. The number of radial rotor and stator slots can be determined by the surface area required to remove the desired amount of heat from the machine. One specific embodiment is designed to provide an approximately one to six ratio of slot width to active material between the slots. Disclosed embodiments may be, for example, an open drip proof machine or a totally enclosed machine.

Some embodiments can additionally comprise an entrance chamber near one end of the housing, a second chamber, one or more axial fans that direct the cooling material in an axial direction from the entrance chamber to the second chamber, and a channel or passageway disposed between the stator and the housing that allows for generally axial flow of the cooling material after the cooling material passes through the radial rotor slots and through the radial stator slots. Disclosed embodiments may further comprise one or more radial fans designed to direct the cooling material in a radial direction, one or more side vents, one or more bottom vents, one or more coolant inlets, one or more coolant outlets, and/or one or more external heat exchangers, such as heat exchanger fins. In some embodiments, the one or more radial fans are designed to direct the cooling material radially outward to exit through the vent(s). Some embodiments of a machine further comprise a radiator configured to cool the cooling material and/or a heat exchanging back plate. Disclosed machines can be, for example, open drip proof or totally enclosed machines.

One specific example of a machine comprises a rotor body configured for rotation on a shaft that defines an axis, a stator radially spaced from the rotor body, wherein the rotor body and the stator each have a plurality of radially extending slots such that a cooling fluid can flow through the slots in a radial direction, wherein the slots in the rotor body are generally aligned with the slots in the stator and the slots are spaced apart at generally regular intervals, a housing that at least partially encloses the rotor body and the stator, an entrance chamber defined near one end and a second chamber defined near an opposite end, one or more axial fans positioned within the housing an configured to direct the cooling fluid in a generally axial direction from the entrance chamber to the second chamber, the one or more axial fans being mounted on the shaft, a passageway defined between the stator and the housing that allows for axial flow of the cooling fluid downstream of the rotor and stator slots, one or more radial fans configured to direct the cooling material in a radial direction, and at least one vent defined in the housing to allow the cooling fluid to exit the machine, wherein the cooling fluid flows in a first generally axial direction into the entrance chamber and between the rotor and the shaft, then in a generally radial direction outward through the rotor slots and the stator slots, then through the passageway, flowing in a second generally axial direction approximately 180 degrees rotated from the first generally axial direction, and then in a generally radial direction.

Also disclosed is a method for transferring heat away from a machine. The heat may be transferred to, for example, a surrounding environment. Such a method can comprise providing a rotor body and stator, providing one or more radial slots in the rotor body and in the stator, and flowing a cooling fluid through the slots, wherein the cooling fluid flows in a generally axial direction, then in a generally radial direction, then in a generally axial direction, and then in a generally radial direction.

Flowing the cooling fluid along an airflow pattern can cool components of the machine. Such methods can be used on, for example, open drip proof or totally enclosed machines. Some specific embodiments comprise flowing a cooling fluid in an axial direction and then in a radial direction. Other embodiments comprise flowing a cooling fluid in a first axial direction, then in a radially outward direction, then in a second axial direction substantially 180 degrees offset from the first axial direction, and then again in a radially outward direction. In some embodiments, such as some embodiments using a totally enclosed machine, at the end of the airflow pattern, the cooling material may flow in a radially inward direction, to re-circulate the cooling material through any heat exchanger present and then continuing through the machine in a closed circuit.

Disclosed embodiments can allow for an essentially universal machine that can be easily adapted to either TE or ODP operations. For example, one embodiment comprises a machine designed to be converted from an ODP configuration to a TE configuration by replacing parts of the casing while using the same rotor, stator, and shaft for both configurations.

The foregoing and other objects, features, and advantages of the present machine cooling schemes will become more apparent from the following detailed description, which proceeds with reference to the accompanying figures.

### BRIEF DESCRIPTION OF THE DRAWINGS

FIG. 1 shows a plan view in section of a prior art ODP cooling system.

FIG. 2 shows a plan view in section of a prior art TE cooling system.

FIG. 3 shows a plan view in section of one embodiment of an ODP cooling system.

FIG. 4 shows a sectioned perspective view of another embodiment of an ODP cooling system.

FIG. 5 shows a plan view in section of one embodiment of a TE cooling system.

FIG. 6 shows a sectioned perspective view of another embodiment of a TE cooling system.

### DETAILED DESCRIPTION

As used in this application and in the claims, the singular forms “a,” “an,” and “the” include the plural forms unless the context clearly dictates otherwise. Additionally, the terms “having” and “includes” means “comprises.” Further, the term “coupled” means physically, electrically and/or electromagnetically coupled or linked and does not exclude the presence of intermediate elements between the coupled items.

Although the operations of embodiments of the disclosed method are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed system, method, and apparatus can be used in conjunction with other systems, methods, and apparatus. Additionally, the description sometimes uses terms like “produce” and “provide” to describe the disclosed method. These terms may be high-level abstractions of the actual operations that can be performed. The actual operations that correspond to these terms can vary depending on the particular implementation and are discernible by a person of ordinary skill in the art.

As used herein, the terms “motor,” “generator,” and “machine” are not meant to be limiting, and embodiments described with respect to one are equally applicable to the others. Further, each term includes induction, synchronous, wound rotor, and permanent magnet configurations. As used herein, the terms “axial direction” and “generally axial direction” mean “in a predominantly axial direction,” and include directions that are perfectly axial, substantially axial, and within ninety degrees of axial. Similarly, as used herein, the terms “radial direction” and “generally radial direction” include directions that are both radially inward and radially outward, unless otherwise specified. Further, the terms “radial direction” and “generally radial direction” mean “in a predominantly radial direction,” and include directions that are generally inward towards the shaft and generally outward from the shaft, as well as directions that are substantially clockwise or counterclockwise around the shaft. Finally, the term “radial direction” includes directions that are perfectly radial, substantially radial, and within ninety degrees of radial.

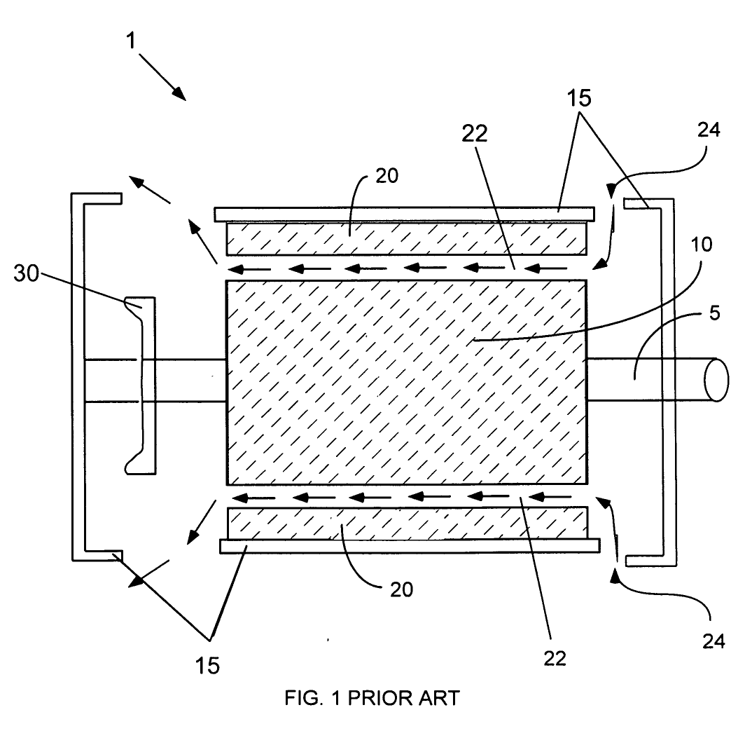

FIG. 1 illustrates a prior art open drip proof (ODP) machine cooling system. A machine 1 has a drive shaft 5, and a rotor 10. The rotor 10 is located in the center of a housing 15, with a stator 20 between the housing 15 and rotor 10. The rotor 10 rotates along with the drive shaft 5, while the stator 20 remains stationary. Movement of the rotor 10 past the stator 20 can generate electricity, as well as heat. Heat is generated in the rotor 10 and the stator 20 due to eddy currents, magnetic hysteresis, and resistive losses. In this prior art method of dispersing heat, air from the external environment enters the machine 1 through openings in the housing 15 and flows in an axial direction indicated by arrows 24. The air moves through an air gap 22 between the rotor 10 and the stator 20. The air may be driven, such as by a fan 30 that rotates with the drive shaft 5. In this manner, cooling air (or other cooling fluid or cooling material) flows through the machine 1, directed along the air gap 22, and then exits the machine 1 through openings in the housing 15 near the opposite end of the machine 1 from where it initially entered the machine 1.

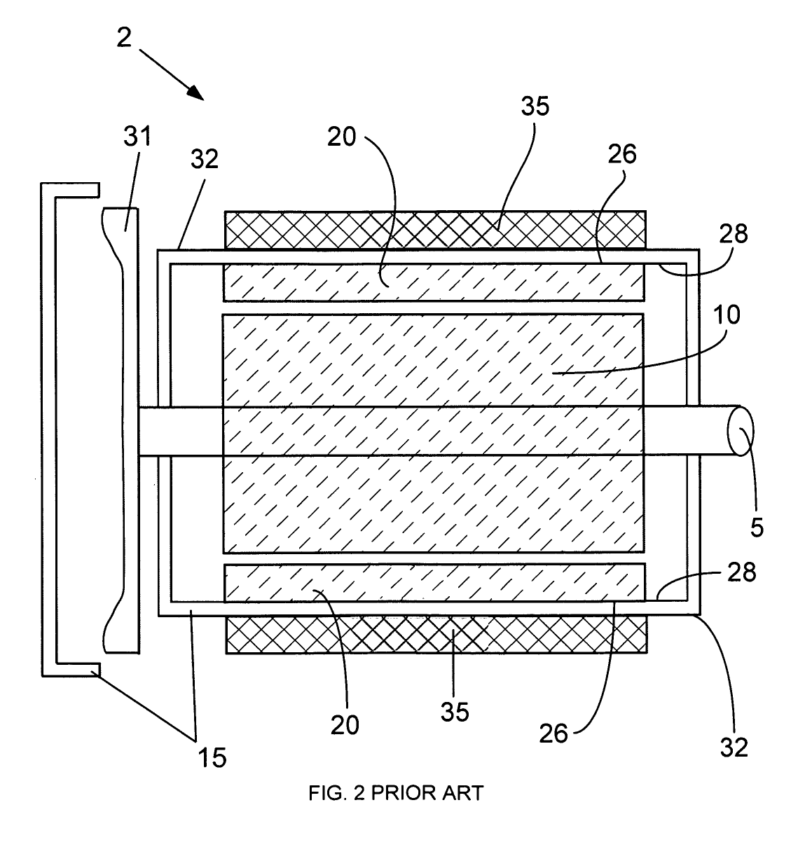

FIG. 2 shows a prior art totally enclosed (TE) machine cooling system. Similar to the ODP machine shown in FIG. 1, a TE machine 2 has a drive shaft 5, a rotor 10, a housing 15, and a stator 20. The TE machine 2 is usually significantly larger than an ODP machine of the same horsepower rating because the TE stator 20 contains significantly more back iron than an ODP stator contains, in order to conduct heat towards an outer surface 26 of stator 20. The outer surface 26 of stator 20 can be adjacent an inner surface 28 of housing 15. Because the TE machine 2 is totally enclosed inside the housing 15, the heat must be dissipated through the housing 15, from housing inner surface 28 to housing outer surface 32. External heat exchange fins 35, located adjacent the outer surface 28 of housing 15, can dissipate the heat from the housing 15 and stator 20. An external fan 31 can help move the air past the fins 35 and TE machine 2. While this cooling scheme can provide sufficient cooling, the excess materials internally and externally are costly and heavy and can be inefficient.

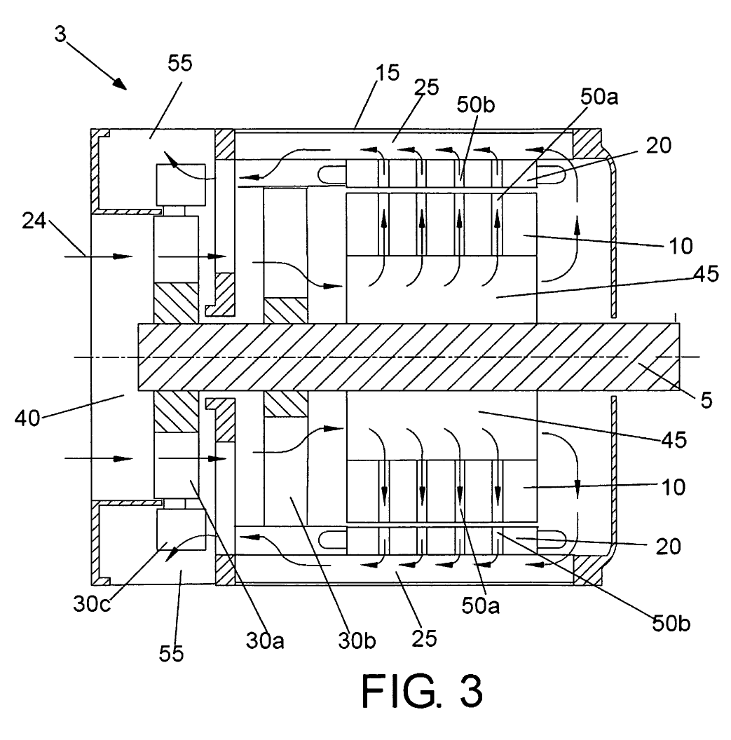

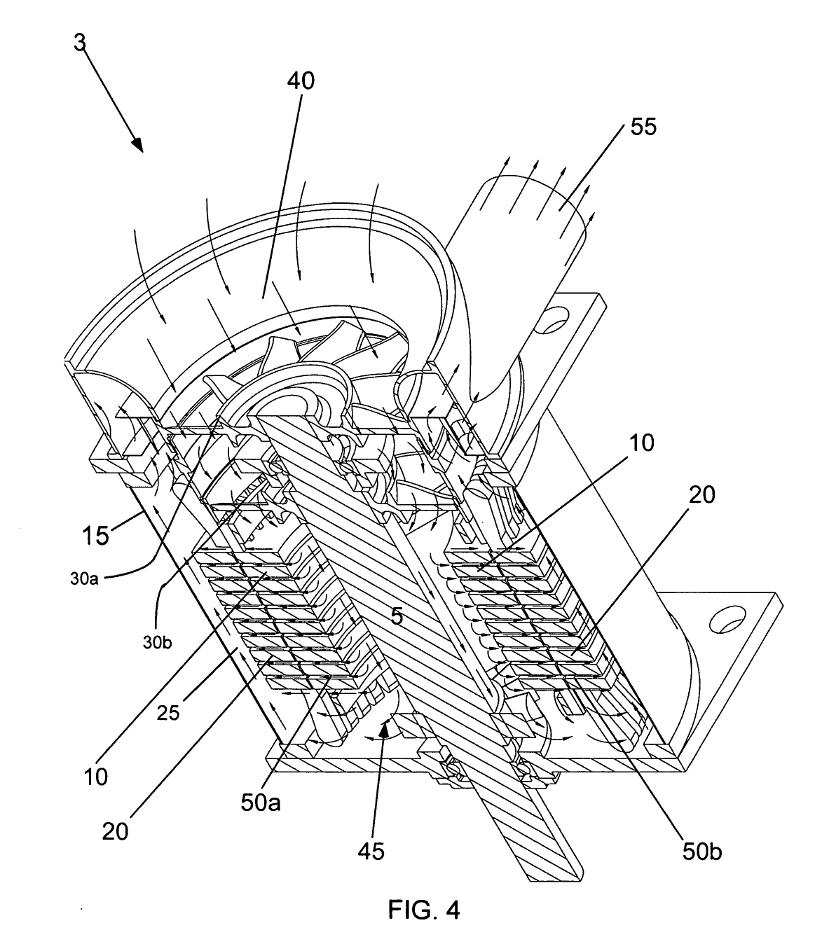

FIGS. 3 and 4 show embodiments of an ODP machine 3 with an improved airflow and cooling scheme. Generally, machine 3 can be provided with a rotor 10 that defines a longitudinal axis through the center of the machine 3. Air, flowing in the direction indicated by arrows 24, is drawn into a machine 3 and enters an entrance chamber 40. The entrance chamber 40 houses a first axial fan 30a, which is mechanically driven by a rotor shaft 5 of the machine 3. In the illustrated embodiment, the first axial fan 30a moves the air to a second axial fan 30b, which moves the air into a second chamber 45. Entrance chamber 40 can be larger than the second chamber 45, thus allowing more space for a larger first axial fan 30a than for the second axial fan 30b. The use of more than one axial fan (such as the first axial fan 30a and the second axial fan 30b) can increase flow of the cooling material through the machine. Alternative embodiments may comprise more or fewer axial fans. For example, in some embodiments, only one axial fan is provided.

In moving from the first chamber 40 to the second chamber 45, the cooling air can flow in a generally axial direction (e.g. in a direction generally or substantially parallel to the longitudinal axis defined by the rotor 10). The air then moves in a radial direction, first through slots 50a in a rotor 10 and then through slots 50b in a stator 20. The slots 50a are preferably aligned with the slots 50b and disposed in a radial direction such that the cooling air can flow through the slots in a radial direction, such as from the center of the machine out towards the housing, or from the second chamber 45 towards a passage or channel 25. Thus, the slots 50a and 50b can essentially serve as a radial fan, cooling the air as it passes through. Next, the air flows in an axial direction, through the channel 25, and exits through side or bottom vents 55. When flowing through passage 25, the cooling air may be flowing in an axial direction substantially reversed (e.g., rotated approximately 180 degrees) from the initial axial direction it traveled when moving from the first chamber 40 to the second chamber 45. The air optionally can be propelled by a radial fan 30c.

The vents 55 shown are at the back of the machine 3 but may be positioned anywhere on or adjacent the external housing 15. The vents 55 can potentially reduce or eliminate the return axial journey of the cooling air (i.e. the vents 55, in some embodiments, can substantially prevent cooling air from flowing back through the air channel 25, in the opposite direction). The disclosed cooling scheme can provide significant flow of air over the rotor 10 and stator 20, which can improve cooling of the machine 3.

The number and type of axial fans 30a, 30b, and radial fan 30c can be varied in different embodiments. For example, some embodiments of an ODP machine include only one or more internal fans, such as axial fan 30a, without any external fans. Similarly, different embodiments can include different combinations of fans 30a, 30b, and 30c. Thus, each fan 30a, 30b, and 30c is optional, and is not present in all embodiments. Factors that can affect the design of fans 30a, 30b, 30c include the length of the air flow path, the number and width of slots 50a, 50b, and the number and angle of bends in the air flow path.

Prior art machines lack slots in the stator 20 and rotor 10, leaving fewer surfaces accessible for heat transfer. When the machine 3 is produced, the stator 20 and rotor 10 each can be manufactured with a series of laminations. The slots 50a, 50b, also referred to as gaps or spacers, can be created by maintaining a space between each layer of the laminated rotor and stator cores (e.g. by placing a spacer between stacks of magnetic flux conducting laminates). An approximately one-to-six ratio of gap to solid material, measured linearly, in the rotor and stator can be effective in specific embodiments. For example, one embodiment has gaps of approximately 0.375 inches for each approximately 1.5 inches of laminate stack. Another embodiment has gaps of approximately 0.25 inches for each approximately 1.5 inches of laminate stack. A higher or lower ratio may be used in different embodiments. The exact solid to gap ratio and the gap width can be determined by one of ordinary skill in the art for the specific machine under consideration.

Although the rotor 10 moves relative to the stator 20, therefore creating electricity, the slots can be aligned in a manner which allows air to flow through them during operation of the machine. After passing through the slots 50a, 50b, the air can move to the channel 25 between the stator 20 and the machine housing 15, and out through a side vent 55 which, in the illustrated embodiment, is in the form of a hot air discharge duct.

The slots 50a, 50b cause a slight reduction in the density of active magnetic material (and thus may require longer copper coils), but the increased cooling capability achieved can compensate for the decreased size of active magnetic material by increasing the performance capacity of the active material due to more efficient cooling.

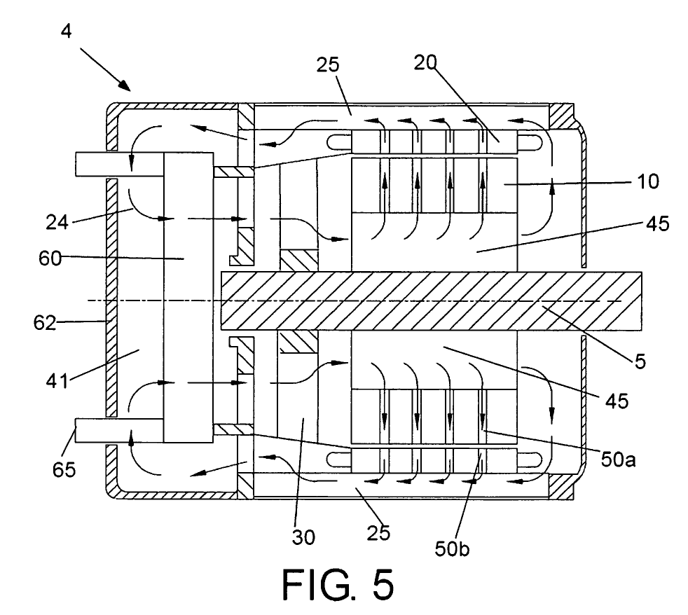

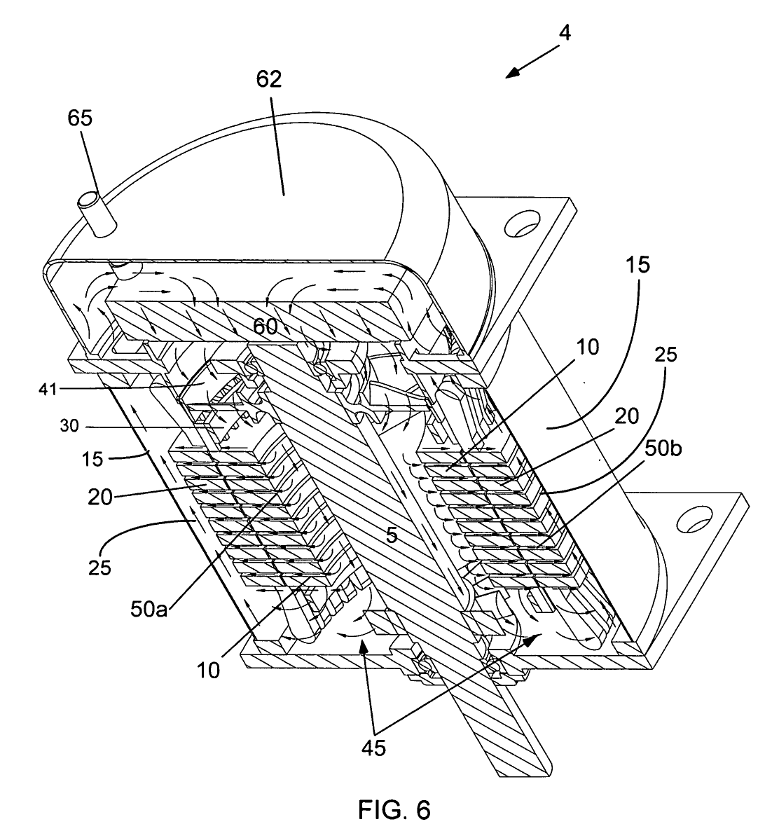

FIGS. 5 and 6 show a totally enclosed (TE) machine 4. As one skilled in the art understands, while these types of machines are generally referred to as “totally enclosed,” the machines are not always air tight (i.e., they are generally substantially totally enclosed, rather than truly totally enclosed). The design is similar to the ODP machine 3 illustrated in FIGS. 3 and 4, except that it is a TE machine, and it, in the illustrated embodiment, uses a heat exchanger, such as radiator 60, to dissipate heat. Other embodiments can use additional radiators and/or alternative heat exchangers. The radiator 60 can be provided with one or more coolant inlets 65 optionally passing through the back plate 62. Additionally, the radiator 60 can include one or more coolant outlets optionally passing through the back plate 62. Use of the radiator 60 to aid the cooling process can reduce the weight and cost of the machine 4.

Within the TE machine 4, the air can flow over the radiator 60, where hot air can exchange heat with relatively cool radiator coolant to produce cooler air. Air can then flow into a first chamber 41, and then drawn by an axial fan 30 in an axial direction along the drive shaft 5 and into a second chamber 45. The axial fan 30 can be attached to and mechanically driven by the machine's drive shaft 5. Air can then flow outward in a radial direction through slots 50a, 50b in the rotor 10 and stator 20 respectively, and into passages 25, provided between the stator 20 and the housing 15. The slots 50a and 50b can essentially serve as a radial fan. The passages 25 serve as a return path for the cooling air and then move the air axially past the radiator 60, where the air can then be drawn radially along a back plate 62 before beginning the process again. This closed-loop system can provide consistent cooling substantially without allowing any exchange of outside air, thus keeping internal components free of dust, water, or corrosive substances.

In an alternate (not illustrated) embodiment of a TE machine, the back plate 62 can be made of aluminum or other thermally conductive material with heat exchanging fins extending into the first chamber 41. External heat exchanging fins may be provided outside the machine for transferring heat from the machine to the ambient atmosphere. The external fins may have air forced over them with a fan, or they may be part of a passive oil cooling system such as found on utility transformers. In further alternative embodiments, the external fins may have active liquid cooling or they may rely purely on natural convection over the warm surface of the external fins.

It should be noted that while some Figures illustrate a permanent magnet machine, the embodiments are not limited to permanent magnet machines, and can include other types of machines, such as induction machines. Additionally, it should be noted that some Figures illustrate optional features that need not be present in all embodiments of the presently disclosed machines.

In the specific embodiments described herein, air is described as the internal cooling fluid but alternative embodiments can use thermal oils, helium, hydrogen, nitrogen, argon, or other cooling fluid in addition to or instead of air, as considered appropriate for the particular embodiment.

As can be seen in the above figures, disclosed embodiments of ODP and TE machines can have the same or similar electromagnetic and active material designs. Because the different configurations can be based on the same basic design, it can be easier to manufacture both in the same facility. The majority of the manufacturing may be identical, with only the final steps differing, primarily involving the back end of the machine. This can create a more efficient and cost-effective manufacturing process.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. I therefore claim as my invention all that comes within the scope and spirit of these claims.

1. A machine comprising:
a housing that at least partially encloses the machine;
a rotor body positioned at least partially within the housing and having a length defining an axial direction;
a drive shaft configured to drive the rotor, at least part of the rotor body being spaced radially from the drive shaft so as to define an internal chamber between the rotor and the shaft; and
a stator spaced radially from the rotor body, wherein the rotor body and the stator each have at least one radially extending slot such that a cooling material can flow through the slots in a radial direction.

2. The machine of claim 1, wherein the stator and the rotor body have a plurality of radially extending slots, wherein each slot is axially adjacent each other and substantially regularly spaced in an axial direction.

3. The machine of claim 2, wherein the housing comprises an entrance chamber near one end of the housing.

4. The machine of claim 3, wherein the housing comprises one or more axial fans that direct the cooling material in an axial direction from the entrance chamber to the internal chamber.

5. The machine of claim 4, further comprising a channel disposed between the stator and the housing that allows for generally axial flow of the cooling material after the cooling material passes through the rotor slots and through the stator slots.

6. The machine of claim 5, further comprising one or more radial fans designed to direct the cooling material in a radial direction.

7. The machine of claim 6, further comprising at least one vent, wherein the one or more radial fans are designed to direct the cooling material radially outward to exit through the at least one vent.

8. The machine of claim 2, wherein the ratio of a width of the slots measured in the axial direction to the width of the active rotor material or active stator material between the slots is approximately one to six.

9. The machine of claim 1, wherein the machine is an open drip proof machine.

10. The machine of claim 1, wherein the machine is a totally enclosed machine.

11. The machine of claim 10, wherein the machine further comprises a radiator configured to cool the cooling material, and wherein the radiator is positioned within the housing.

12. The machine of claim 10, wherein the machine further comprises a heat exchanging back plate.

13. The machine of claim 12, further comprising external heat exchanging fins.

14. The machine of claim 11, further comprising a coolant inlet and/or a coolant outlet.

15. A machine, comprising:
a rotor body configured for rotation on a shaft that defines an axis;
a stator radially spaced from the rotor body, wherein the rotor body and the stator each have a plurality of radially extending slots such that a cooling fluid can flow through the slots in a radial direction, wherein the slots in the rotor body are generally aligned with the slots in the stator and the slots are spaced apart at generally regular intervals;
a housing that at least partially encloses the rotor body and the stator;
an entrance chamber defined near one end and a second chamber defined near an opposite end;
one or more axial fans positioned within the housing and configured to direct the cooling fluid in a generally axial direction from the entrance chamber to the second chamber, the one or more axial fans being mounted on the shaft;
a passageway defined between the stator and the housing that allows for axial flow of the cooling fluid downstream of the rotor and stator slots;
one or more radial fans configured to direct the cooling material in a radial direction; and
at least one vent defined in the housing to allow the cooling fluid to exit the machine,
wherein the machine is configured to direct the cooling fluid such that the cooling fluid flows in a first generally axial direction through the entrance chamber and between the rotor and the shaft, then in a generally radial direction outward through the rotor slots and the stator slots, then through the passageway, flowing in a second generally axial direction approximately 180 degrees rotated from the first generally axial direction, and then in a generally radial direction.

16. The machine of claim 15 wherein the machine is designed to be converted from an ODP configuration to a TE configuration, where both the ODP and the TE configurations use the same rotor, stator, and shaft.

17. A method for transferring heat away from a machine comprising:
providing a drive shaft, rotor body and stator, wherein the rotor body is spaced radially from the drive shaft so as to define a chamber;
providing one or more radial slots in the rotor body and in the stator; and
flowing a cooling fluid through the chamber and then through the slots, wherein the cooling fluid flows in a generally axial direction, then in a generally radial direction, then in a generally axial direction, and then in a generally radial direction.

18. The method of claim 17, wherein the machine is an open drip proof machine.

19. The method of claim 18, wherein the cooling fluid flows in a first generally axial direction, then in a generally radially outward direction, then in a second generally axial direction approximately 180 degrees rotated from the first generally axial direction, and then again in a generally radially outward direction.

20. The method of claim 17, wherein the machine is a totally enclosed machine.

21. The method of claim 20, wherein the cooling fluid flows in a first generally axial direction, then in a generally radially outward direction, then in a second generally axial direction approximately 180 degrees rotated from the first generally axial direction, and then in a generally radially inward direction.

22. The machine of claim 5, wherein the channel is a substantially continuous annular channel that extends substantially entirely around the circumference of the stator.

23. The machine of claim 15, wherein the passageway extends substantially entirely around the circumference of the stator.
